(19) United States
(12) Patent Application Publication
(10) Pub. No.: US 2017/0138829 A1
(43) Pub. Date: May 18, 2017

(54) METHOD FOR DETERMINING ELASTIC PROPERTIES OF A MOTOR VEHICLE CABLE HARNESS

(71) Applicant: GM GLOBAL TECHNOLOGY OPERATIONS LLC, Detroit, MI (US)

(72) Inventor: Meike SCHAUB, Ruesselsheim (DE)

(73) Assignee: GM GLOBAL TECHNOLOGY OPERATIONS LLC, Detroit, MI (US)

(21) Appl. No.: 15/349,293

(22) Filed: Nov. 11, 2016

(30) Foreign Application Priority Data
Nov. 13, 2015 (DE) 102015014770.6

(51) Int. Cl. G01N 3/40

(52) U.S. Cl. CPC G01N 3/40; B60R 16/0207

(57) ABSTRACT

A method for determining elastic properties of a motor vehicle cable harness is disclosed. At least one elastic property of at least one test cable is measured as a function of a force acting on the test cable. At least one elastic characteristic of the test cable is estimated from the measurement. At least one elastic property of a cable harness including a plurality of cables is calculated based on the at least one determined elastic characteristic.

### CROSS-REFERENCE TO RELATED APPLICATION

This application claims priority to German Patent Application No. 102015014770.6, filed Nov. 13, 2015, which is incorporated herein by reference in its entirety.

### TECHNICAL FIELD

The present disclosure pertains to the determination, in particular the simulation and calculation, of elastic properties of motor vehicle components, in particular of cable harnesses or cable looms to be arranged in a motor vehicle, which in each case are composed of a plurality of individual cables.

### BACKGROUND

For their installation and laying in a motor vehicle, cable looms or cable harnesses often have to be adapted to given geometrical requirements. The geometrical adaptation of cable harnesses or cable looms composed on a plurality of cables typically requires a bending of the entire cable harness to suit requirements in order to adapt the same to the given geometrical space conditions. In the process, elastic deformations and where appropriate also plastic deformations often occur.

For a virtual analysis of a motor vehicle to be conceptualized it is required to represent all motor vehicle components as realistically as possible in virtual prototypes. By a computer-supported and purely virtual conceptualization of a motor vehicle, any component overlaps or collisions can be determined even before the development of real prototypes. This makes it possible to lower development costs.

In order to represent the total construction of a planned vehicle as realistically as possible it is additionally required to also simulate flexible vehicle components, such as for example cable harnesses or cable looms as real as possible. In order to keep the calculation effort for the simulation of elastic properties of cable looms or cable bundles within limits it is desirable to provide a model for the elastic behavior of differently configured cable looms, which reflects the actual elastic behavior of cable looms as good and precise as possible.

For the simulation of elastic motor vehicle components, such as for example of cable harnesses or cable looms, it is desirable, furthermore, to determine the geometrical shapes that are unfavorable for long-term durability even based on simulation in order to be able to minimize the wear of such flexible components and increase the long-term durability of such components.

### SUMMARY

In accordance with the present disclosure, a method for determining elastic properties of a motor vehicle cable harness is provided. At least one elastic property of at least one test cable is measured as a function of a force acting on the test cable. At least one elastic characteristic of the test cable is determined from the measurement. At least one elastic property of a cable harness is calculated including a plurality of cables based on the at least one determined elastic characteristic.

Here it is provided in particular that by the measurement of a test cable the elastic characteristics characterizing the test cable are determined so that solely on the basis of those elastic characteristics the corresponding elastic properties of a cable harness including a plurality of such test cables can be purely determined or simulated by calculation.

As elastic properties, a torsional or a bending stiffness of the test cables are measured in particular. The bending stiffness in this case is determined in particular based on a three-point bending test. The cable is supported at two points which are spaced from one another in cable longitudinal direction, and wherein an external force radially acts on the cable at such a point from the outside which is located between the two support points.

Once in this manner at least one test cable has been characterized at least with respect to an elastic property, for example with respect to a torsional characteristic or with respect to a bending characteristic, a corresponding elastic characteristic for the cable harness including a plurality of such test cables can be determined purely by calculation by the method proposed here.

According to a further development thereof it is provided in particular that a plurality of test cables with different cable cross sections are each measured individually or in cable bundles. Measuring a plurality of test cables each with different cable cross sections makes possible interpolation or approximation later on, in particular of cables which have a cross section that differs from the cross section of measured test cables. When for example an elastic characteristic of a first test cable is measured with a cross section of 1 mm and when furthermore a corresponding elastic characteristic of a second test cable, for example with a diameter of 5 mm, it is possible, based on the measured elastic characteristics for test cables with different diameters, to calculate corresponding elastic characteristics also for cables whose diameter is between the diameter of the first test cable and that of the second test cable.

Based on the measured test cable a corresponding elastic property, a torsional characteristic or a bending characteristic of a cable can be approximated for example, the diameter of which amounts for example to 2.5 mm

It is provided, furthermore, that not only individual test cables but also entire bundles of test cables are measured. In this regard, an elastic characteristic such as for example a torsional characteristic or a bending characteristic corresponding to a single test cable can also be determined for a cable bundle. The elastic behavior of a group of cables, for example of a cable loom or cable harness bundled in a variety of manners can quite significantly differ from the sum total of the properties of those individual cables, of which the cable bundle or the group of cables concerned is composed. Depending on the bundling, friction forces between individual cables lead to an entirely different bending and torsional behavior of the cable bundle concerned compared with the corresponding elastic behavior of the individual cables.

By measuring and characterizing both individual test cables and also individual cable bundles, cable or cable bundle-specific elastic characteristics can be empirically determined here, on the basis of which an approximation of simulation of cables or cable looms with respect to their elastic behavior can be carried out, which are to be concretely used in a motor vehicle, and which with respect to their elastic properties were not examined in practice beforehand.

According to a further configuration, a plurality of test cables or a plurality of cable bundles each with a different sheathing are measured. Different groups of sheathings are possible as sheathing, wherein within each group of sheathings different sheathing types can be provided.

Possible different groups of sheathings are on the one hand wrapped sheathings, for example sheathings wrapped with tapes following a spiral course, but on the other hand also tubular sheathings, for example corrugated tube sheathings.

Within a wrapping-based sheathing group, different wrapping types, for example the use of different tapes with different elastic or plastic properties as well as different geometries are conceivable. In addition, the manner of the wrapping can be configured differently. Spiral wrappings can have different degrees of overlap between wrappings following one another in axial direction or cable longitudinal direction. Furthermore, based on the cable longitudinal direction, both complete cable wrappings but also cable wrappings only in certain regions are also conceivable. By measuring individual test cables or cable bundles each with different sheathing, the elastic properties of the cable harness can be determined sheathing group-specifically or sheathing type-specifically purely by calculation.

In this way, a wide range of groups and types of sheathings, which bring about or can influence a wide range of elastic properties of a cable harness concerned, can be taken into account comparatively precisely with a comparatively low calculation effort during the simulation or during the calculation of the at least one elastic property of a cable harness.

According to a further configuration, based on the determined elastic characteristics, at least one elastic property of at least one cable differing from the test cable or at least one elastic property of a cable bundle or of the cable harness is determined by approximation or interpolation from at least one elastic characteristic previously determined from the measured cables. The respective geometrical parameters of the test cables as well as cables or cable harnesses which are not measured but determined with respect to their elastic characteristic purely by calculation can be additionally taken into account here.

In the present context, a cable bundle describes a group of individual cables, a cable harness, a cable bundle provided with sheathing.

In addition, the geometrical parameters, in particular the number as well as the cross section of the individual cables belonging to the cable harness or cable loom not measured can be used as input parameters for determining the elastic properties of the cable harness concerned purely in a computer-supported manner

According to a further configuration, a torsion of the at least one test cable as a function of a torsional moment is measured as elastic characteristic, which functions as a force acting on the respective test cable. In this way, a torsional characteristic is determined as elastic characteristic which indicates a linear relationship between the torsion and the torsional moment. In other words, the measurement of the torsion of the test cable is based on a linear relationship between torsion and torsional moment. The torsional characteristic to be determined in this regard constitutes a gradient of a linear relationship between torsion and torsional moment.

In this regard, the torsion of the test cable is to be characterized solely with respect to a single torsional parameter, namely a torsional characteristic G. This makes possible a comparatively simple calculation of the torsion of a cable that has not been measured or of a cable harness including a plurality of such cables.

According to a further configuration, a bending of the test cable as a function of a bending moment acting on the test cable is measured as elastic characteristic of the test cable. In this way, at least one bending characteristic is determined as elastic characteristic, which indicates a linear relationship between the bending and the respective prevailing bending moment. Determining the bending characteristic typically takes place based on an already described three-point bending test. The bending characteristic can also be based on a linear relationship between the bending and the bending moment. Such a linear relationship is suitable in particular for assuming an isotropic or linear bending behavior of a cable or of a cable harness composed of a plurality of cables.

According to a further configuration it is provided, furthermore, to measure the bending of the test cable as a function of the bending moment in such a manner in order to determine at least two bending characteristics as elastic characteristics, each of which indicate a linear relationship between the bending and the bending moment for different ranges of the bending moment. In this way, a plastic or pseudo-plastic bending behavior of a cable loom can be simulated, which comes quite close to the actual bending-elastic behavior of a cable loom composed of a plurality of cables.

For in practice it has been shown that the degree of bending of a cable loom with a steadily increasing bending moment does not follow a linear course but decreases. The functional relationship between the bending and the bending moment can be rudimentarily approximated or simulated by two straight lines, wherein the straight line gradient in a lower range of the bending moment is typically greater than in an upper range of the bending moment. For characterizing the bending behavior of a test cable, two bending characteristics from the measured measurement data and an interface of a transition region between the two different elastic behaviors have to be determined in this regard. In this way it is made possible to not only simulate a linear elastic behavior of a cable harness but also a pseudo-plastic bending behavior of a cable harness.

According to a further configuration it is provided that out of the at least one measured elastic property a series of test cables and the respective associated elastic characteristics and the geometrical parameters of the test cables concerned a function with a series of coefficients is determined, by way of which at least one elastic characteristic of a cable that has not been measured or of a cable bundle or cable harness that has not been measured can be determined. The function can include a plurality of terms of the sum, which in each case have to be multiplied by one of the coefficients. The terms of the sum are based on the measured elastic properties of the test cables and on the geometrical properties of the cable loom concerned, in particular on the number of the test cables contributing to the cable loom and their cross-sectional area.

According to a further configuration, at least one of the coefficients is dependent on the respective sheathing. This means that one of those coefficients is a pure sheathing parameter. In this regard, a sheathing type-specific or sheathing group-specific function is determined for different sheathing groups or sheathing types and provided for the simulation of the elastic properties of a cable bundle or cable harness.

According to a further configuration of the method, the function F₁ for a cable harness with a cable bundle having a sheathing of type i has the following construction:

logP=c₁ᵢ+c₂ᵢlogD+c₃log²D+c₄log²D+c₅ logA

Here, all wrapping types are combined in the coefficients c₃, c₄ and c₅. Furthermore,

$$D = {\sum }_{i = 1}^{m} {n}_{i} {d}_{i}$$

Wherein
nᵢ indicates the number of the cables of type i; and
dᵢ the respective measured elastic property, for example a measured bending or torsional stiffness of the individual test cable.
   Then, dᵢ, wherein aᵢ is the nominal cross section of the cable of type i, and N is the total number of all cables belonging to the cable harness or cable bundle.

$$A = \frac{1}{N} {\sum }_{i = 1}^{m} {n}_{i} {a}_{i}$$

Wherein
aᵢ is the nominal cross section of the cable of type i, and
N is the total number of all cables belonging to the cable harness or cable bundle.
   The parameter P furthermore stands as place holder for an elastic characteristic G, E or K to be determined in each case for the cable harness.

Furthermore, all sheathing types of a sheathing group are combined in one and the same function. Merely the coefficients c₁ᵢ and c₂ᵢ are separate constants, which are characteristic and different for each sheathing type. In this way, one and the same function can be used for a group of cable harnesses based on tape wrapping. The individual different wrappings types i are characterized by the coefficients c₁ᵢ and c₂ᵢ. By contrast, a comparable function for another group of sheathings can be determined by empirically and numerical approximation, which for example relates to corrugated tube sheathings.

According to an alternative configuration of the method, the further function F₂ has the following construction:

logP=c₁ᵢ+c₂ᵢ logD+c₃log²D+c₄log²D+cₛlogN

Compared with the function F₁, the function F₂ has an always demanded monotony. With respect to the measured parameters, the function F₁ can have a slightly lower approximation error than the function F₂.

Both functions F₁ and F₂ can be used independently of one another as rudimentary function for the elastic approximation of the cable harness. They can be equally used for different elastic characteristics G, E and K. When the function F₁ or F₂ is used for example for the approximation of the torsional characteristics G of the cable harness, an elastic and measured parameter d, corresponding to the torsion of the respective test cable is used. The same applies also to the calculation and approximation of the elastic parameters E and K.

According to a further configuration, at least one of the functions F₁, F₂ is determined in each case for at least two different groups of sheathings, namely wrapping sheathings or tube sheathings. Within a group of wrapping sheathings or tube sheathings, one of the functions F₁, F₂ can be used for all different sheathing types, wherein in particular the coefficients c₁ᵢ, c₂ᵢ characterize the respective sheathing type.

According to a further aspect, the present disclosure, furthermore, relates to a method for developing a motor vehicle, wherein at least one elastic property of a cable harness to be installed in the motor vehicle is determined with a previously described method. The method is suitable, in particular, for the simulation as realistic as possible of a motor vehicle, in particular before realizing a real existing prototype.

According to a further aspect, a computer program for determining elastic properties of a motor vehicle cable harness is finally provided. Here, the computer program, when executed on a computer, is configured to measure at least one elastic property of at least one test cable as a function of a force acting on the test cable, determine at least one elastic characteristic of the test cable from the computer-supported measurement, and calculate at least one elastic property of a cable harness including a plurality of cables based on the at least one determined elastic characteristic. In other words, the computer program is configured for the computer-supported implementation of the previously described method. In this regard, all previously described method steps and characterizing features of the method also apply equally to the computer program.

### BRIEF DESCRIPTION OF THE DRAWINGS

The present disclosure will hereinafter be described in conjunction with the following drawing figures, wherein like numerals denote like elements.

FIG. 1 shows a schematic lateral view of a motor vehicle;

FIG. 2 shows a cross section through a cable harness composed of a plurality of cables;

FIG. 3 shows a linear relationship between a torsion of a test cable and a torsional moment;

FIG. 4 shows a non-linear relationship however characterized by two linear regions between the bending of a test cable and the bending moment acting on the test cable;

FIG. 5 represents a computer-supported approximation of a linear bending behavior in certain sections on the basis of measurement data which were determined with a test cable; and

FIG. 6 illustrates a flow diagram of the method for determining the elastic characteristic of a motor vehicle cable harness.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

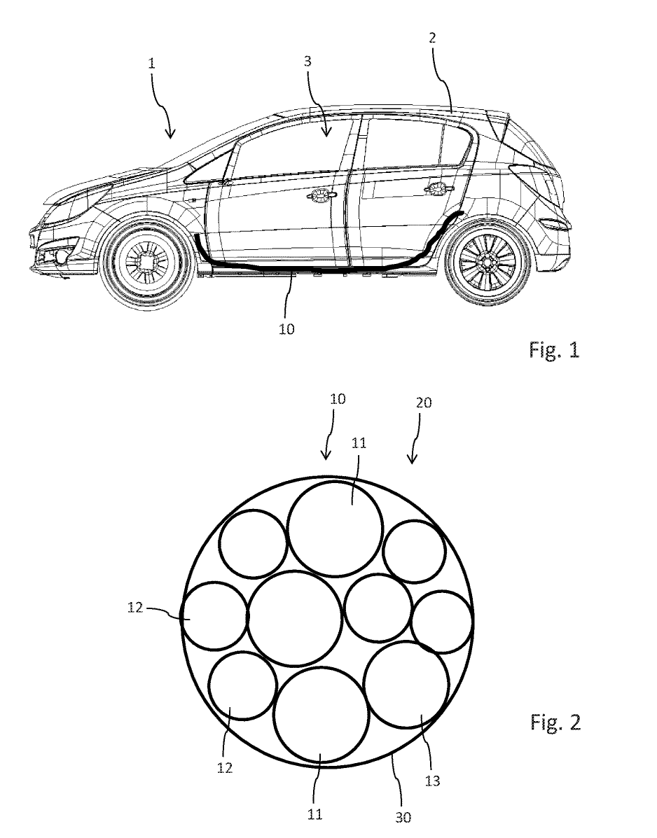

In FIG. 1, a motor vehicle 1 with a motor vehicle body 2 and with a passenger cell is shown in a schematic lateral view, which delimits a motor vehicle interior 3 towards the outside. Furthermore, a cable harness 10 routed in the motor vehicle 1 marked with reference number 10 is schematically shown.

FIG. 2 shows such a cable harness 10 in cross section. The cable harness includes a plurality of individual cables 11, 12, 13 which are arranged lying against one another more or less regularly or irregularly and which are provided with a circumferential sheathing 30. As tape-like wrapping, the sheathing 30 can for example hold the cables 11, 12, 13 in the form and arrangement shown in FIG. 2. However, flexible tubes or hoses are alternatively also provided, which enclose the individual cables 11, 12, 13 of the cable harness 10 at least in longitudinal direction of the cables 11, 12, 13 in some sections.

The method for determining the elastic properties of a motor vehicle cable harness 10 serves in particular for simulating the elastic behavior during the laying of the cable harness 10 in the motor vehicle 1. In this regard, it is provided, according to the flow diagram according to FIG. 6, that in a first step 100 at least one elastic property, for example the torsion T or the bending B of one or a plurality of test cables 11, 12 is measured. Based on a measurement, during the course of which for example the torsion is measured as a function of a torsional moment or the bending as a function of a bending moment, corresponding elastic characteristics characterizing the torsion or the bending of the test cable 11, 12 concerned can be determined in the following step 102.

Based on those empirically determined characteristics, an applicable elastic property, for example a torsion or a bending of a cable harness 10 including one or a plurality of cables 11, 12, 13 can then be determined by calculation in a following step 104.

In this way, a comparatively large and heterogeneous group of variously configured cable harnesses 10 can be calculated and simulated with respect to its elastic behavior by measuring the elastic properties and determining the characteristics characterizing the elasticity of the test cables 11, 12 concerned. The calculation effort required for this is significantly smaller than when elastic properties of each individual cable and its interaction with other cables of a cable harness were to be determined by calculation separately and in each case individually.

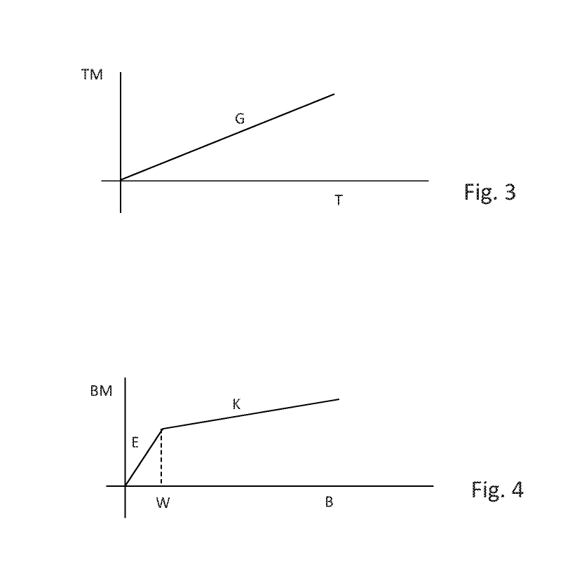

In FIG. 3, the linear course of a torsion T as a function of a torsional moment TM acting on a pressed cable 11, 12 to be assumed here is shown. During the measurement of a test cable 11, 12 an approximately straight characteristic line is obtained, which insofar characterizes and determined a torsional characteristic G. For the bending B of a test cable 11, 12, a similar linear course of a bending characteristic can likewise be assumed. In this regard, a linear relationship between the bending B and the bending moment BM, thus an isotropic bending behavior of an individual test cable 11, 12 and of a cable harness 10 can be used as a base.

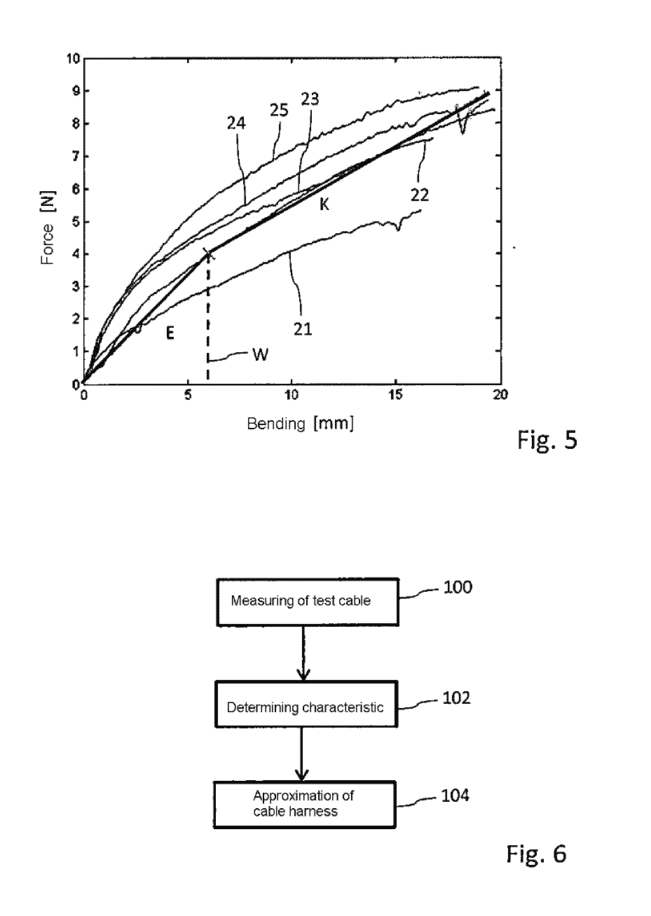

However, in FIG. 4 an anisotropic, pseudo-plastic behavior of a bending of a test cable 11, 12 is shown. The bending B runs approximately linearly with rising bending moment BM up to a point W of the bend. That linear region can be characterized with a bending characteristic E. For bending degrees greater than the limit value W, the characteristic however has a flatter course. There, a gradient that is smaller in magnitude or a lower bending characteristic K should consequently be assumed there. In FIG. 5, a plurality of characteristic lines 21, 22, 23, 24, 25 of a test cable 11 are shown, which show the relationship between a bending moment BM or force acting on the test cable 11 and the bending B resulting from this. Furthermore, the limit value W is stated, below which the bending behavior is linearly approximated on the basis of the bending characteristic E.

Above that limit value W for the bending B, the bending behavior with a further bending characteristic K is likewise described linearly and in the form of a straight line.

Such diagrams shown in FIG. 5 are carried out for a multitude of all kinds of test cables 11, 12 each with different cross sections, different sheathing types and different sheathing groups. Corresponding measurements are carried out both with respect to the torsion and also with respect to the bending so that both for the bending behavior and also for the torsional behavior the previously mentioned functions or equations F₁ or F₂ can be used as a base for characterizing and for describing the respective elastic behavior.

Based on the test cables 11, 12, the characteristics E, W and K as well as G in the case of a torsion can be determined. In a computer-supported manner, the coefficients c1ᵢc2ᵢ, c3, c4 and c5 can then be numerically determined for the all kinds of test cables and for all kinds of sheathing types in each case of a sheathing group. Once a function F₁ or F₂ has been determined based on the test cables 11, 12, the respective elastic characteristic, in particular E, G or K can be determined by calculation, in each case sheathing type-specifically for a cable set with a known number of different dimensioned cables, in particular with a number of cables with different cross sections.

For different sheathing groups, for example for sheathings based on tubes or sheathings based on wrappings, different functions F₁ or F₂ can each be determined separately based on corresponding test cables.

Measuring the at least one elastic property of the test cables 11, 12, determining at least one elastic characteristic of the test cable concerned, determining the coefficients c1, c2, c3, c4, c5 and of the functions F₁ or F₂ and also the determining of elastic characteristics of cables 13, cable bundles 20 or cable harnesses 10 which are not measured takes place in a computer-supported manner In this regard, the previously described computer program is designed to carry out all method steps described here and to determine in a computer-supported manner the elastic properties of cable harnesses based on the previously determined functions F₁ or F₂. Here, a method of the least squares can be used.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-14. (canceled)

15. A method for determining elastic property of a motor vehicle cable harness comprising:
measuring an elastic property of a test cable as a function of a force acting on the test cable;
determining an elastic characteristic of the test cable from the measurement;
calculating an elastic property of a cable harness having a plurality of cables based on the determined elastic characteristic; and
modeling the motor vehicle cable harness using the calculated elastic property.

16. The method according to claim 15, wherein further comprising measuring a plurality of test cables each with a different cable cross section.

17. The method according to claim 16, further comprising measuring a plurality of test cables each with a different sheathing.

18. The method according to claim 15, determining at least one elastic property of at least one cable differing from the test cable by approximation or interpolation based on the determined elastic characteristics.

19. The method according to claim 15, further comprising measuring a torsion of the test cable measured as a function of a torsional moment in order to determine a torsion characteristic as the elastic characteristic for indicating a linear relationship between the torsion and the torsional moment.

20. The method according to claim 15, further comprising measuring a bending of the test cable as a function of a bending moment acting on the test cable in order to determine at least one bending characteristic as the elastic characteristic ;for indicating a linear relationship between the bending and the bending moment.

21. The method according to claim 20, further comprising bending and measuring the test cable in such a manner to determine at least two bending characteristics as the elastic characteristic, which in each case indicates a linear relationship between the bending and the bending moment for different ranges of the bending moment.

22. The method according to claim 15, further comprising determining a function with a series of coefficients from the at least one measured elastic property of a series of test cables and the respective associated elastic characteristics and geometrical parameters by way of which at least one of the elastic characteristics of a cable can be determined.

23. The method according to claim 22, wherein at least one of the coefficients is dependent on a respective sheathing.

24. The method according to claim 22, wherein the function for a cable harness with a sheathing of type i has the following construction:
logP=c₁ᵢ+c₂ᵢlogD+c₃log²D+c₄log²D+c₅logA
wherein:
$$D = {\sum }_{i = 1}^{m} {n}_{i} {d}_{i}$$
nᵢ indicates the number of the cables of type i;
dᵢ the respective measured elastic property of the test cable;
$$A = \frac{1}{N} {\sum }_{i = 1}^{m} {n}_{i} {a}_{i}$$
aᵢ is the nominal cross section of the cable of type i; and
N is the total number of all cables belonging to the cable harness.

25. The method according to claim 24, wherein the function for a cable harness with a sheathing of type i has the following construction:
logP=c₁ᵢ+c₂ᵢlogD+c₃log²D+c₄log²D+c₅logN

26. The method according to claim 24, wherein at least the function is determined in each case for at least two different groups of sheathings.

27. A method for developing a motor vehicle, wherein at least one elastic property of a cable harness to be installed in the motor vehicle is determined prior to an installation in the motor vehicle according to the method of claim 15.

28. A non-transitory computer readable medium comprising computer program, which when executed on a computer, is configured to:
measure an elastic property of a test cable as a function of a force acting on the test cable;
determine an elastic characteristic of the test cable from the measurement;
calculate an elastic property of a cable harness having a plurality of cables based on the determined elastic characteristic; and
model the motor vehicle cable harness using the calculated elastic property.
